(19) United States
(12) Patent Application Publication
(10) Pub. No.: US 2014/0160820 A1
(43) Pub. Date: Jun. 12, 2014

(54) Electrical Current Transformer for Power Distribution Line Sensors

(71) Applicant: Michael Wayne McKinley, Xenia, OH (US)

(72) Inventor: Michael Wayne McKinley, Xenia, OH (US)

(73) Assignee: Grid Sentry LLC, Beavercreek, OH (US)

(21) Appl. No.: 13/709,226

(22) Filed: Dec. 10, 2012

(51) Int. Cl. H01F 29/02; H02H 7/055; H02M 7/06

(52) U.S. Cl. CPC H01F 29/025; H02M 7/06; H02H 7/055
USPC 363/126; 336/192; 361/35

(57) ABSTRACT

An electrical current transformer for installation upon a power distribution line including a generally annular, split core and a secondary winding. The secondary winding includes a first winding portion, wound with a first winding polarity about the split core, and a second winding portion, wound with a second, opposite winding polarity about the split core, and a tap. The transformer further includes first and second rectifiers, electrically connecting a tap output to terminals of the first and second winding portion opposite the tap, respectively, and a tap control for controlling the tap output, where the tap is both electrically connectable to the output to provide an additive connection and electrically isolatable from the output to cause a subtractive connection. The tap control controls the tap output in response to a condition sensed in the powered circuit. Self-cancellation may be achieved by using windings having an equal number of turns.

### FIELD

The subject matter described herein generally relates to electrical current transformers and, more particularly, to an electrical current transformer adapted to power current sensors and other electronics installed upon power distribution lines in AC electrical power grids.

### BACKGROUND

Electrical current sensors are frequently installed upon electrical transmission or distribution lines in regional power grids to support power line monitoring and other power management activities. In typical designs, an electrical current transformer draws power for the current sensor electronics, as well as means for communicating with a monitoring station run by the grid operator, from the transmission or distribution line itself. Such designs may include a battery backup in order to power the sensor and communications electronics in the event of a power failure, but are otherwise designed to operate within a specified range of current after installation upon any particular transmission or distribution line.

Electrical current transformers, or CTs, are usually passive devices in which an alternating current flowing through a primary winding, in the present case an electrical power transmission or distribution line, creates an alternating current in a secondary winding, in the present case a portion of a power supply for an over-the-line installed sensor. The primary side alternating current creates an oscillating magnetic field (which may be concentrated within a magnetic core, if necessary), and that oscillating magnetic field electromagnetically induces an alternating current in each secondary winding “turn” that is oriented generally perpendicularly to the magnetic flux vector. The induced alternating current may be used to power sensor electronics and/or other electronics without any direct electrical connection between the primary side/power line and the secondary side powered electronics, and without requiring any electrical connection to a second power line or an earth ground. However, the induced current will be proportional to the current flowing through the primary winding/power line, with the degree of proportionality fixed by the basic construction of the CT (principally, the ratio of turns in the respective windings, but also by the geometry of the respective windings, the characteristics of the core material, etc.). If the induced current is not consumed by a load, voltages in the secondary winding will build to levels likely to cause arcing within the CT or CT-powered electronics. Some active CTs depart from fixed proportionality by mechanically altering the ratio of turns: the secondary winding is constructed with multiple “taps” which permit a mechanism to select an otherwise fixed number of consecutive winding turns for inclusion in the secondary side circuit, and a tap-switching mechanism connects a pair of taps (intermediate taps and/or end taps) to the secondary side circuit to change the ratio of turns and thus the current induced on the secondary side. These tap-switching mechanisms provide some control over the power delivered to the secondary side powered electronics; however, in both passive and active CTs, any power not consumed by the powered electronics must be consumed by another load in order to control voltage. In most current sensor devices installed over power transmission or distribution lines, a separate load, usually comprising a resistance heater thermally connected to a radiator, is used to dissipate excess power. Design constraints relating to the heater-radiator combination ultimately limit the maximum primary side current rating of each individual device. However, economic and environmental constraints relating to the cumulative ‘parasitic’ load of hundreds or thousands of such devices deployed within a power distribution network also limit the desirability of deploying a single, broad capacity device across the power distribution grid.

The current carried in an electrical power distribution line will be approximately proportional to the power demand of the households, businesses, and infrastructure served by that portion of the power distribution grid; and, in contrast to regional power transmission lines, the grid operator typically cannot regulate the load on a distribution line other than through the use of intentional “blackouts.” Thus, a CT powering a current sensor device installed over a power distribution line should be operable both during low power demand periods (such as the demand minima ordinarily observed between 2 to 4 A.M.) and very high power demand periods (such as the peak demands observed between 4 to 6 P.M., especially during heat waves with high cooling degree day values), even up to the point of line failure. Nonetheless, many existing current sensor devices significantly limit their rated current range (most importantly, the maximum primary side current rating) due to constraints upon size (particularly of radiator components), cost (of heater-radiator combinations and/or any active tap switching mechanism), and overall device complexity (particularly with regard to multi-tap switching mechanisms).

### SUMMARY

Presented is an electrical current transformer for power distribution line sensors which employs magnetic subtraction to eliminate-the need for complex tap switching mechanisms and a separate power-dissipating load. The electrical current transformer is suitable for installation over power distribution lines having widely varying current flows, and may be combined with an electrical current sensor and/or other electromagnetic sensors to provide a power distribution line sensor having a very broad primary side current range. Further objects and advantages of the disclosed electrical current transformer will be apparent from the detailed discussion provided below.

In a first aspect, an electrical current transformer for installation upon a power distribution line comprises a generally annular, split current transformer core having a secondary winding. The secondary winding includes a first winding portion, wound with a first winding polarity about the split core, and a second winding portion, wound with a second, opposite winding polarity about the split core, and an intermediate tap. The electrical current transformer further comprises a first rectifier, electrically connecting an output of the intermediate tap to a terminal of the first winding portion opposite the intermediate tap, and a second rectifier, electrically connecting the output of the intermediate tap to a terminal of the second winding portion opposite the intermediate tap. The electrical current transformer yet further comprises an intermediate tap control for controlling the output of the intermediate tap, wherein the intermediate tap is both electrically connectable to the output to provide an additive connection between the first and second winding portions, and electrically isolatable from the output to cause a subtractive connection between the first and second winding portions. The intermediate tap control automatically controls the output in response to a condition sensed in a circuit powered by the first and second rectifiers.

In a second aspect, an electrical current transformer for installation upon a power distribution line comprises a generally annular, split current transformer core having a secondary winding. The secondary winding includes a first winding portion, wound with a first winding polarity about the core for a number of turns, and a second winding portion, wound with a second, opposite winding polarity about the core for an equal number of turns, and a cancellation tap. The electrical current transformer also comprises a first rectifier, electrically connecting an output of the cancellation tap to a terminal of the first winding portion opposite the cancellation tap, and a second rectifier, electrically connecting the output of the cancellation tap to a terminal of the second winding portion opposite the cancellation tap. The electrical current transformer yet further comprises a cancellation tap control for controlling the output of the cancellation tap, wherein the cancellation tap is normally electrically connected to the output but electrically isolatable from the output to effectively cancel current flow through the secondary winding. The cancellation tap control automatically controls the output in response to a condition sensed in a storage capacitor powered by the first and second rectifiers.

Several additional features, functions, and advantages can be achieved in various embodiments, examples of which can be seen with reference to the following description and drawings.

### BRIEF DESCRIPTION OF THE DRAWINGS

The accompanying figures depict various embodiments of the electrical current transformer. A brief description of each figure is provided below.

FIGS. 1A and 1B are perspective views of a generalized embodiment of the electrical current transformer secondary winding and core.

FIG. 2 is a schematic diagram of the generalized embodiment illustrating an additive connection between the first and second winding portions.

FIG. 3 is a simplified diagram of the generalized embodiment illustrating a subtractive connection between the first and second winding portions.

FIG. 4A is a schematic view of a first example of a first embodiment of the electrical current transformer.

FIG. 4B is a schematic view of a second example of a first embodiment of the electrical current transformer.

FIG. 4C is a schematic view of a third example of a first embodiment of the electrical current transformer.

FIG. 5 is a schematic diagram of a second embodiment of the electrical current transformer.

FIG. 6 is a schematic view of the second embodiment of the electrical current transformer.

FIG. 7 is a perspective view of an overmold embedding the split core and secondary winding. One portion of the overmold is shown in phantom lines to provide enhanced context.

FIG. 8 is a perspective view of the split core and secondary winding mounted within a housing. The overvoltage protection stage, rectification stage, and other components of the electrical current transformer may be housed within the central bay of the housing alongside an electrical current sensor and other secondary side electronics.

### DETAILED DESCRIPTION

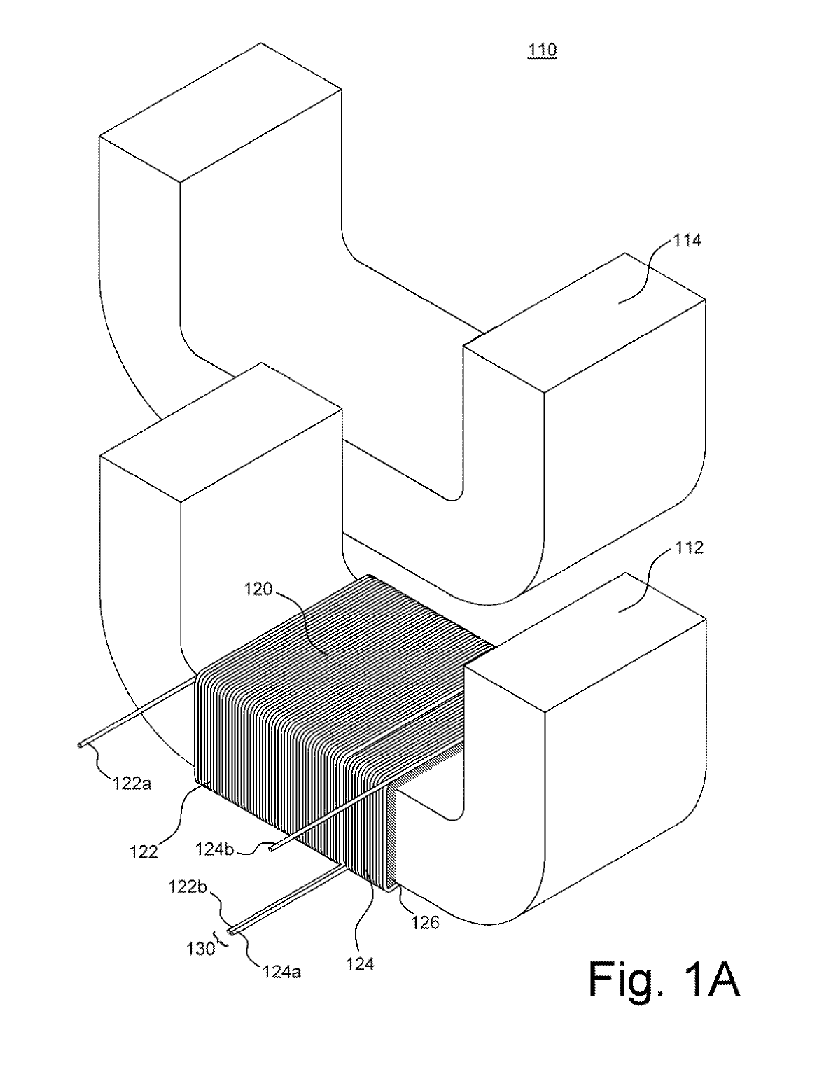

With initial reference to FIGS. 1A and 1B, an electrical current transformer adapted for installation over a power distribution line may be based upon a generally annular split core 110. As illustrated, the split core 110 may have two substantially identical “U” shaped halves 112, 114, however those of skill in the art will recognize that the core may have two substantially identical “L” shaped halves, two dissimilar “C” and “I” shaped portions, a fully split toroid, a hinged and partially split annulus, or a flexible and partially split toroid or annulus and, consequently, these and other partially or fully split shapes are intended to be encompassed within the term “generally annular split core.” The split core 110 may be a magnetic core, manufactured from a materials such as silicon steel or ferrite, a non-magnetic core, manufactured from materials such as polybutylene terephthalate/polycarbonate (PBT+PC) resin, or a so-called “air core.” Magnetic core materials will improve inductive coupling with a power distribution line, but such an improvement may not be necessary or desirable if the lines are expected have a minimum current sufficient to inductively power secondary side electronics via windings disposed around lighter, non-magnetic core materials.

At least a portion of the split core 110 includes a secondary winding 120 having a first winding portion 122, wound with a first winding polarity p₁ about the split core 110, a second winding portion 124, wound with a second, opposite winding polarity p₂ about the core, and a tap 130. In a first construction of the split core 110, shown in FIG. 1A, the first winding portion and the second winding portion may be physically wound in a first winding direction d₁ and an opposite winding direction d₂, respectively, by discontinuously winding the first and second portions 122, 124 about the split core and electrically connecting the end of the first winding portion 122b to the start of the second winding portion 124a (the “start” and “end” being relative to the respective winding directions, not any particular physical location with respect to the core 110) through the tap 130. In such a construction, the start of the first winding portion 122a and the end of the second winding portion 124b would constitute terminals for connection to a rectifier stage (not shown in FIGS. 1A and 1B). In a second construction of the split core 110, shown in FIG. 1B, the first winding portion and the second winding portion may be physically wound in the same winding direction, e.g., d₁, but with the winding polarities reversed by electrically connecting the start of the first winding portion 122a to the start of the second winding portion 124a through the tap 130. In such a construction, the end of the first winding portion 122b and the end of the second winding portion 124b would constitute terminals for connection to the rectifier stage. The secondary winding 120 may be wound over a underlayment 126, such as a plastic or felt, to shield the winding from conductive core materials and/or sharp core edges.

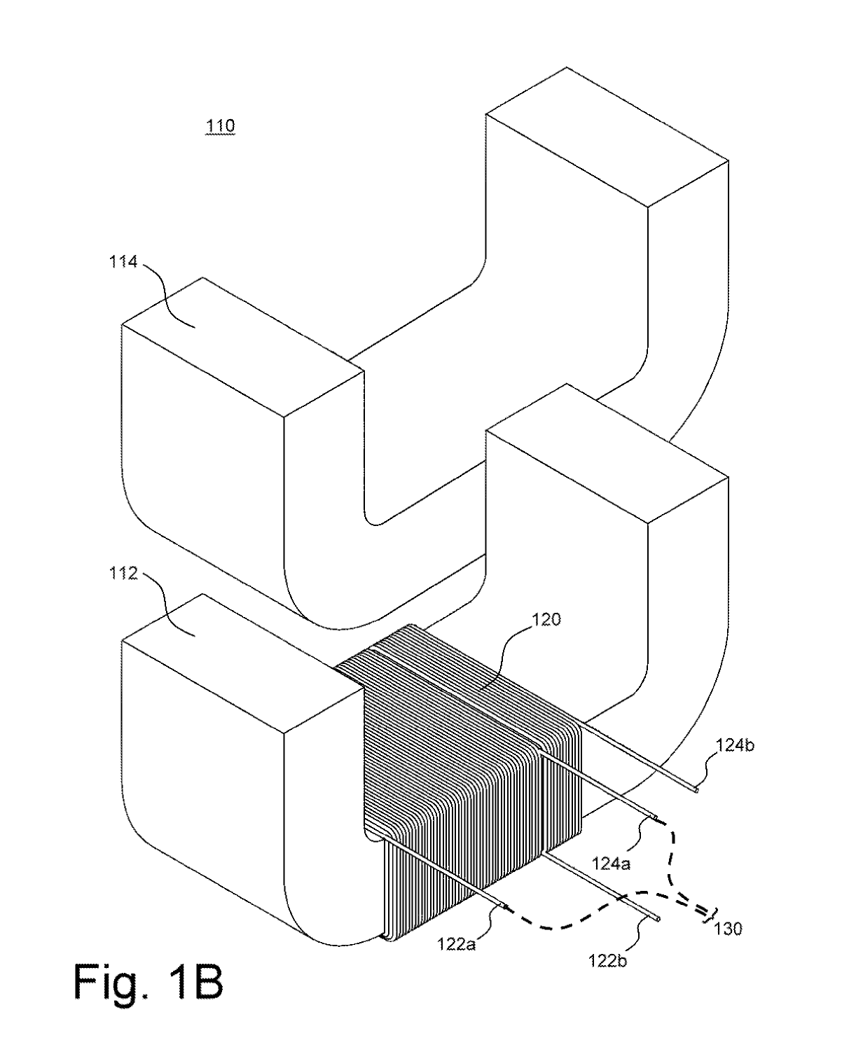

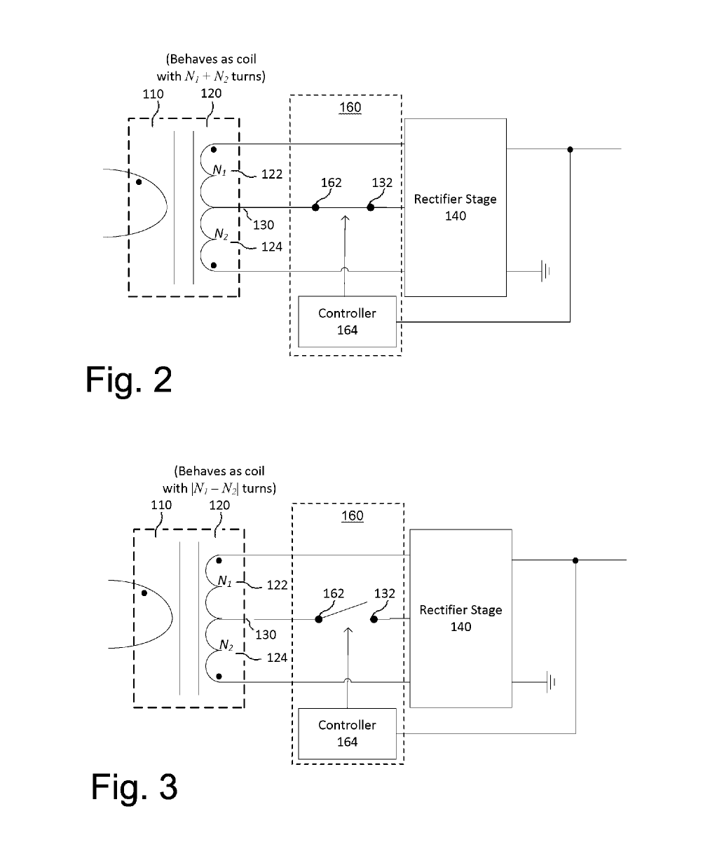

As shown in FIGS. 2 and 3, depending upon the number of turns provided in the first winding portion N₁, the number of turns provided in the second winding portion N₂, and the connection state of the tap 130 to the rectifier stage 140, the secondary winding 120 may function as a winding having an effective total of N₁+N₂ turns or as a winding having an effective total of |N₁−N₂| turns. Consequently, the current (and, indirectly, voltage) induced in the secondary winding 120 may be switched or otherwise varied by a tap control 160 interposed between the tap 130 and an output 132 of the tap. The tap control 160 includes a switch or variable control 162 operated by a controller 164 which senses a condition, typically voltage, in a circuit powered by the rectification stage 140 in order to automatically control the connection state. In a first aspect, where N₁ is greater than N₂, the secondary winding 120 may be switched or otherwise varied by the tap control 160 between an additive mode suited for use when current in the primary winding is comparatively low, such as in the tens of amps, and a subtractive mode suited for use when current in the primary winding is comparatively high, such as in the hundreds of amps. In a second aspect, where N₁ is equal to N₂, the secondary winding may be switched by the tap control 160 between a collection mode and a self-cancellation mode to limit the currents and voltages on the secondary side (i.e., in the rectification stage 140 and powered electronics). The terminals of the secondary winding 120 and the output 132 are connected to the rectification stage 140, as further described below, to convert the AC current induced across the secondary winding 120, or within the first and second winding portions 122, 124, respectively, in additive and collection modes, into a DC current for use by the secondary side powered electronics.

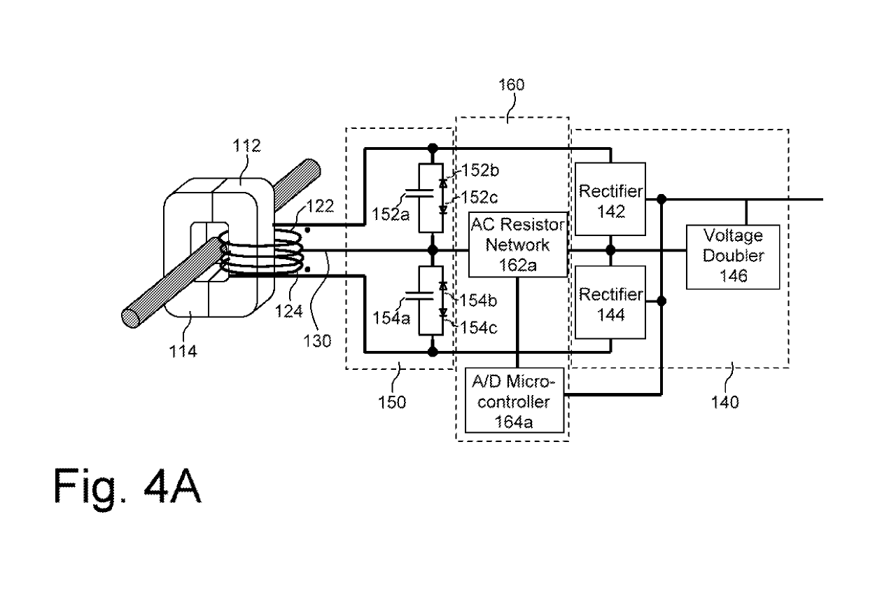

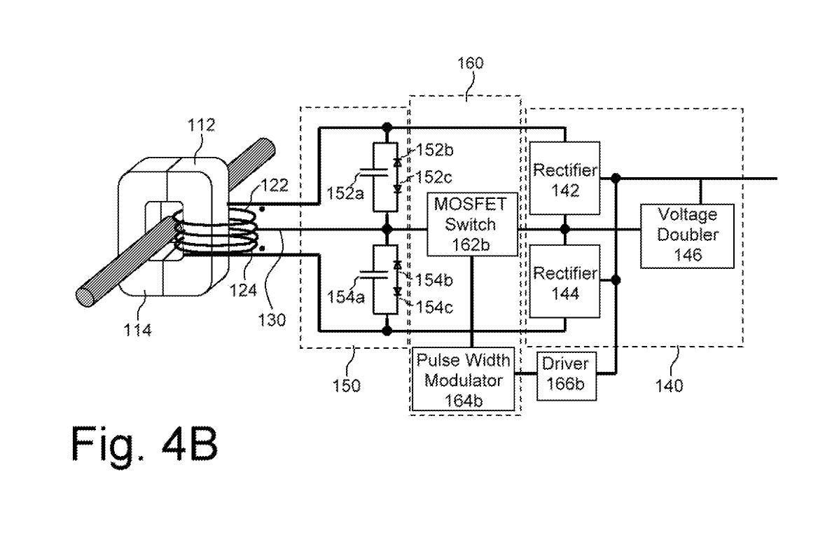

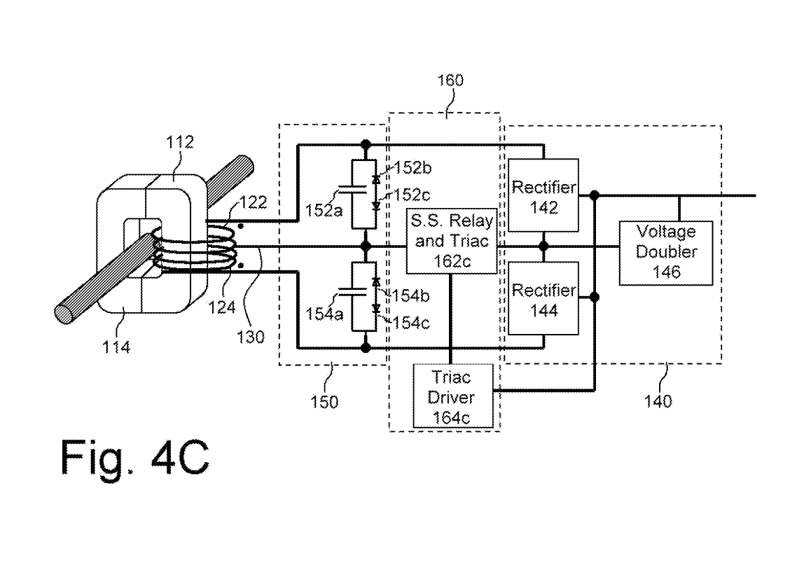

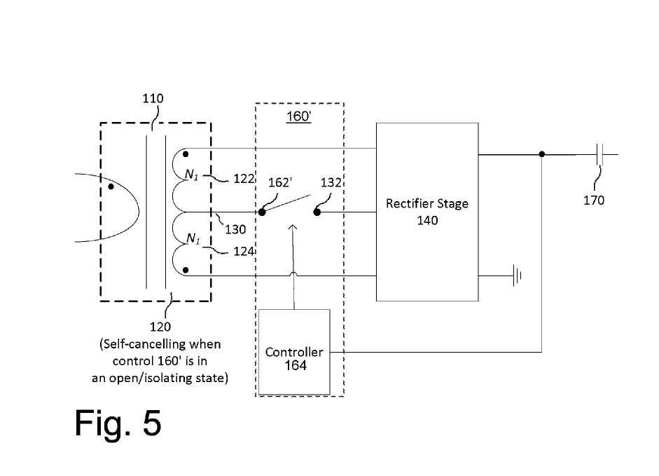

In typical embodiments, shown in FIGS. 4A through 4C and 5, the rectification stage 140 of the electrical current transformer 100 includes a first rectifier 142 electrically connecting the output 132 to a terminal of the first winding portion 122 opposite the tap 130, and a second rectifier 144 electrically connecting the output 132 to a terminal of the second winding portion 124 opposite the tap 130. The first and second rectifiers 142 and 144 may be half wave rectifiers or full wave rectifiers. The rectification stage 140 may also include a voltage multiplier 146 electrically connected to the first and second rectifiers 142 and 144 in a proximate portion of the secondary side circuit. This voltage multiplier 146 may serve to increase the voltage of power provided to the intermediate tap control 160 versus the voltage otherwise present in the secondary side circuit. In many embodiments and constructions, an overvoltage protection stage 150 may be disposed between the secondary winding 120 and this rectification stage 140, serving as a surge protection device to shunt high voltage pulses generated by lightning strikes, switching current spikes, or transmission line shorts away from the rectification stage 140 and secondary side powered electronics. Such an overvoltage protection stage 150 may include a first overvoltage protection portion 152, such as a capacitor 152a and first pair of oppositely oriented diodes or diode-like devices 152b, 152c, (for example, TVS diodes or metal oxide varistors) interconnecting the output 132 to the terminal of the first winding portion 122 in parallel, and a second overvoltage protection portion 154, such as a second capacitor 154a and second pair of oppositely oriented diodes 154b, 154c interconnecting the output 132 to the terminal of the second winding portion 124 in parallel. At voltages above a clamping voltage, the overvoltage protection stage 150 will, at least temporarily, shunt much of the AC current induced in the secondary winding away from the rectification stage 140 and dissipate the resultant power as internal heat. Subsequently, as discussed more generally below, the tap control 160 may switch (or otherwise vary) the secondary winding to a subtractive or self-cancellation mode to minimize the power induced in the secondary side circuit.

In exemplary embodiments of the first aspect, shown in FIGS. 4A through 4C, tap 130 is an intermediate tap permitting switching or other forms of variation between a low primary current mode and a high primary current mode. The intermediate tap control 160 interconnects the intermediate tap 130 to the output 132, and includes a controller that may be a microcontroller, driver, or similar electronic device suited for controlling the particular control mechanism selected, as well as for sensing a condition in the circuit powered by the first and second rectifiers 142, 144. The intermediate tap control 160 may electrically connect the intermediate tap 130 to the output 132 to provide an additive connection between the first and second winding portions 122 and 124, and electrically isolate the intermediate tap 130 from the output 132 to cause a subtractive connection between the first and second winding portions 122 and 124. In some exemplary constructions of the first embodiment, the intermediate tap control 160 merely switches between electrically connected and electrically isolated states, while in other exemplary constructions of the first embodiment, the intermediate tap control 160 may stepwise or continuously vary between electrically connected and electrically isolated states, e.g., by imposing a stepwise or continuously varying resistance between the intermediate tap 130 and the output 132. In a first exemplary embodiment shown in FIG. 4A, the intermediate tap control 160 comprises an AC resistor network 162a and an A/D microcontroller 164a. The A/D microcontroller 164a senses a condition in the circuit powered by the first and second rectifiers 142, 144 and controls the AC resistor network 162a to vary the resistance of an electrical connection between the intermediate tap 130 and the tap output 132. The AC resistor network 162a may be configured with a default low resistance corresponding to a minimum expected primary side current to provide a default additive connection during a cold start of the electrical current transformer (and, most particularly, the A/D microcontroller 164a controlling the AC resistor network 162a). Depending upon the resolution and peak resistance of the network, the A/D microcontroller 164a may merely switch or otherwise variably control the electrical connection so as to electrically isolate, “partially” electrically connect (with a moderate resistance connection), or “fully” electrically connect (with a low resistance connect) the intermediate tap 130 to the output 132. In a second exemplary embodiment shown in FIG. 4B, the intermediate tap control 160 comprises a MOSFET switch 162b and a pulse width modulator 164b. The pulse width modulator 164b may include or be driven by an input driver 166b for compatibility with the circuit powered by the first and second rectifiers. The pulse width modulator 164b senses a condition in the circuit powered by the first and second rectifiers 142, 144 and controls the MOSFET switch 162b to increase or decrease the time fraction in which the intermediate tap 130 is electrically isolated from the output 132. The MOSFET switch 162b is preferably a depletion-mode device in order to default (due to an unpowered gate) to a connected state and thus provide a default additive connection and similar cold start capability. In a third exemplary embodiment shown in FIG. 4C, the intermediate tap control 160 comprises a solid state optical relay and triac 162c, and a triac driver 164c. The triac driver 164c senses a condition in the circuit powered by the first and second rectifiers 142, 144 and controls the optical relay and triac 162c to electrically connect or isolate the intermediate tap 130 from the tap output 132. The optical relay is preferably a normally-closed relay in order to default (due to an unpowered triac and triac driver 162c) to a connected state and thus provide an additive connection and similar cold start capability. The triac itself functions as a zero crossing switch in parallel with the solid state optical relay to minimize high current switching transients to the rectification stage 140. In each exemplary construction, the condition sensed in the circuit powered by the first and second rectifiers 142, 144 will usually be the circuit voltage, but may be a circuit current, the presence of a threshold circuit voltage, the presence of a threshold circuit current, or combinations thereof.

In each of the exemplary embodiments of FIGS. 4A-4C, operation of the intermediate tap control 160 serves to vary the power provided to the secondary side circuit by switching or otherwise varying the apparent ratio of turns in the electrical current transformer 100 between 1:(|N₁−N₂|) and 1:(N₁+N₂). Simple switching between these two extents may be used to switch between a very low primary current mode of operation and a very high primary current mode of operation, so long as the secondary side circuit or powered electronics are manufactured to have a reasonable degree of DC capacitance. The number of turns N₁ and N₂ in the first and second winding portions, respectively, may be selected so that the power supplied to a circuit powered by the first and second rectifiers 142, 144 is sufficient to power an electrical current sensor and communications electronics when current in the power distribution line is comparatively low, such as in the tens of amps, and so that the power generated by the first and second rectifiers 142, 144 is approximately equal to that necessary to power the intermediate tap control 160 when current in the primary winding is comparatively high, such as in the hundreds of amps. The electrical current transformer 100 may then operate in the additive mode when the condition sensed in the circuit, such as circuit voltage, indicates that circuit power insufficient, and operated in the subtractive mode when the condition sensed in the circuit indicates that circuit power is sufficient. In instances where the intermediate tap control otherwise varies the connection state, the electrical current transformer 100 may operate in a stepwise or continuously varying range between the additive mode and the subtractive mode as required by the secondary side powered electronics.

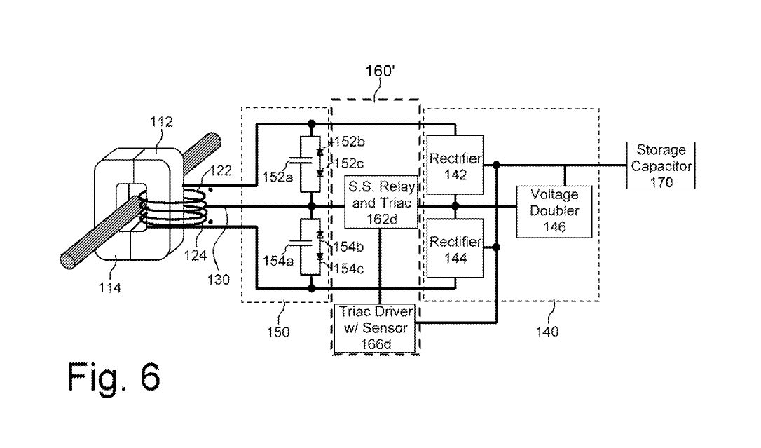

In an exemplary embodiment of the second aspect, shown in FIGS. 5 and 6, the electrical current transformer 100 may include an identical rectification stage 140 (and, optionally, over current protection stage 150) but the first winding portion 122 and second winding portion 124 may have an identical number of turns N₁ so that the tap 130 functions as a cancellation tap 130′. A cancellation tap control 160′ interconnects the cancellation tap 130′ with the output 132 of the cancellation tap and a controller senses the condition of a storage capacitor 170 powered by the first and second rectifiers 142, 144. Consequently, the electrical current transformer serves as a intermittent charging source for the storage capacitor 170 and, advantageously, essentially isolates the secondary side circuit and powered electronics from the primary side/power line when it is not charging the capacitor. The electrical current transformer may consequently have a very high maximum primary side current rating (limited primarily by the specifications of the first and second rectifiers 142, 144 and the switching speed of the cancellation tap control 160′) but still effectively charge a storage capacitor 170 such as a high capacitance electrolytic capacitor or a supercapacitor.

The cancellation tap control 160′ preferably comprises a solid state optical relay and triac 162d, and includes a controller comprising a triac driver 164d and storage capacitor monitoring circuit 166d. The optical relay is preferably a normally-closed relay in order to default (due to an uncharged storage capacitor 170) to a connected state and thus provide a default collection mode for cold start charging of the storage capacitor 170. However, upon electrical isolation of the cancellation tap 130′ from the output 132, current may only flow to the rectifiers 142, 144 from the end taps of the secondary winding 120. Advantageously, due to the opposite winding polarities of the first and second winding portions 122, 124 and the identical number of turns in each, essentially no current will flow across the secondary winding 120 due to magnetic subtraction, i.e., self-cancellation of the currents induced within the secondary winding due to the opposing effects of the oscillating magnetic field upon the first and second winding portions. Thus, the electrical current transformer may place itself in a self-cancellation mode in which no voltage builds up within the secondary winding 120, no power is transferred to the rectification stage 140, and no power needs to be dissipated from the secondary side beyond that required for operation of the secondary side powered electronics. Thus, in contrast to both typical current transformer devices and the exemplary devices of the first aspect (at least, where N₁≠N₂), the secondary side electronics connected to the electrical current transformer 100 need not include any separate resistive load to dissipate excess power, the usual resistive heater may be eliminated, and any radiators, if required, may be scaled down to meet the lesser cooling needs of the sensor and communications electronics in a power distribution line sensor. Those of skill in the art will appreciate that the cancellation tap control 160′ may alternately be substantially identical to the intermediate tap control 160′ of the second exemplary embodiment of the first aspect, with pulse width modulator 164b incorporating or otherwise including a like storage capacitor monitoring circuit 166d.

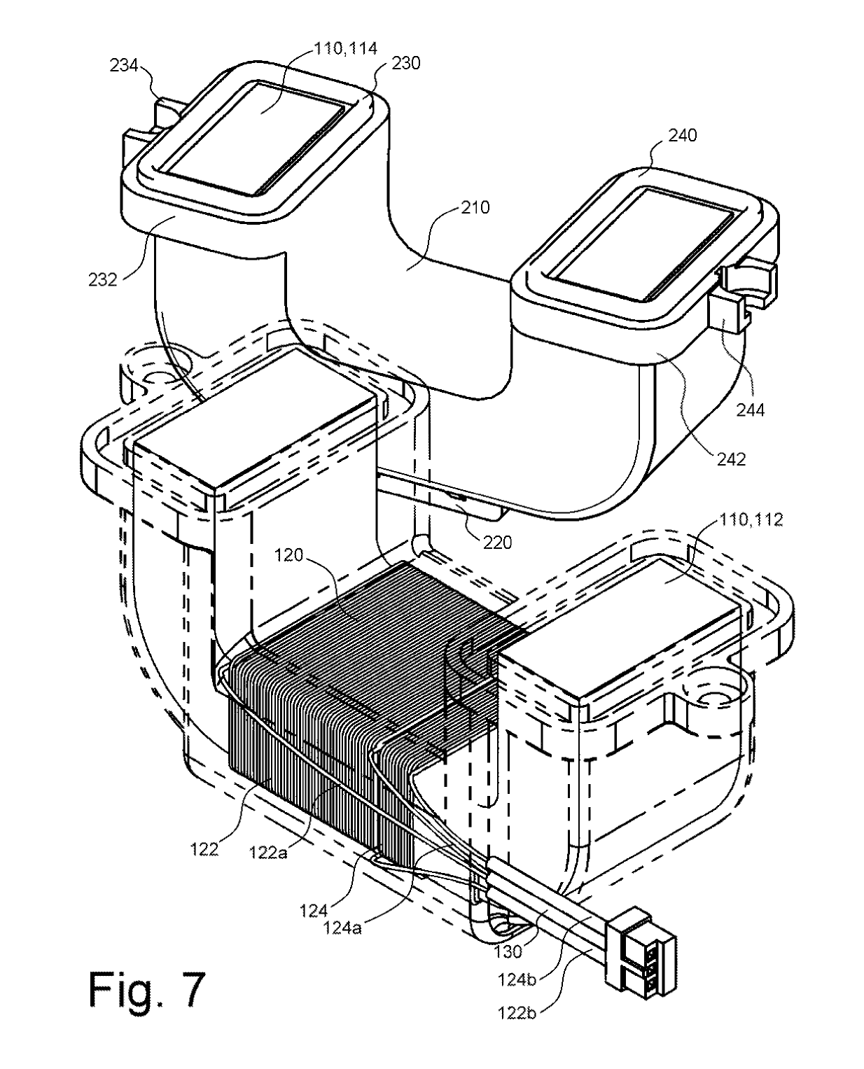

In preferred constructions of the exemplary embodiments, such as that shown in FIG. 7, the split core 110 and secondary winding 120 are embedded within overmold portions 210. Each overmold portion 210 may itself be a fully split but otherwise generally annular structure formed from an electrically insulating material such as polybutylene terephthalate/polycarbonate (PBT+PC) resin. For example, the overmold portion may be formed from Valox® 553, a fiber-reinforced PBT+PC marketed by SABIC Americas, Inc. of Houston, Tex. The surface of the overmold portion 210 may include one or more abutment surfaces 220 for engagement with a complementary abutment surface in a sensor housing. The ends 230, 240 of the overmold portion 210 may also include flanges 232 and 242 for seating upon support surfaces in a sensor housing. In addition, each flange 232, 242 may also include a narrowed, outwardly protecting tab portion 234, 244 for insertion between a pair of guides or ribs provided in a sensor housing. The combination of the flange 232, 242 and tab portion 234, 244 may, upon engagement with the housing structure, thereby resist rotation, radial movement (movement within the plane of the toroid) and longitudinal movement (movement perpendicular to the plane of the toroid) with respect to the housing.

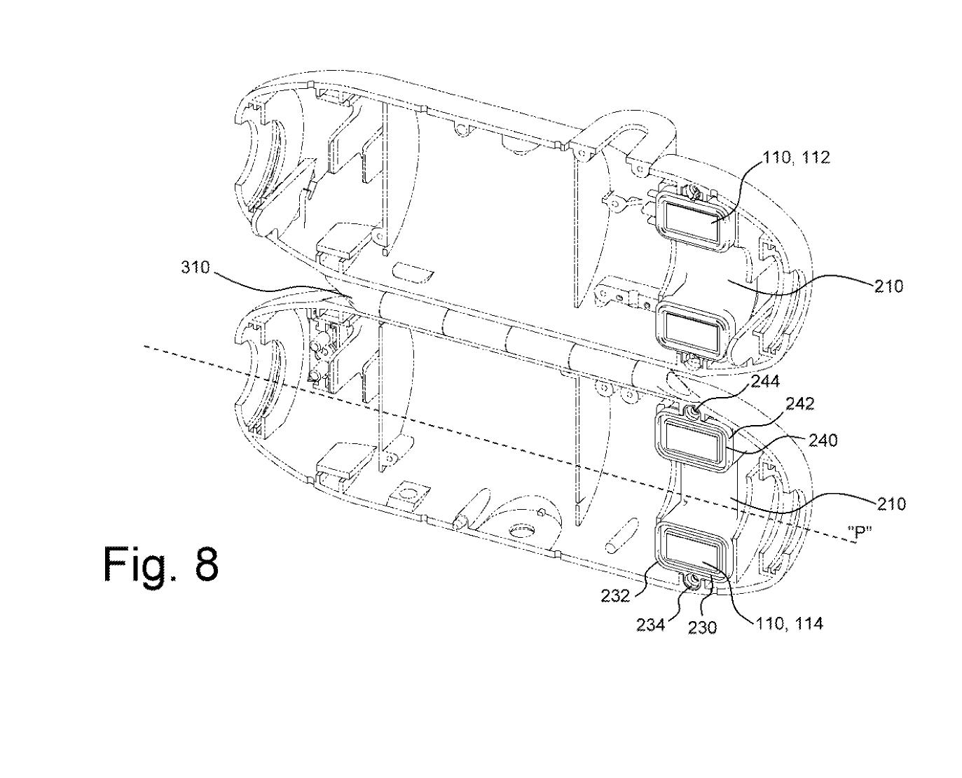

As shown in FIG. 8, in typical embodiments the electrical current transformer (with the split core 110 and secondary winding 120 optionally embedded within overmold portions 210) are mounted within a clamshell sensor housing 300 that can be manipulated by a lineworker to mount the current transformer on a live power distribution line (not illustrated, but coaxially disposed along axis “P”). The clamshell sensor housing 300 may pivot about a hinge mechanism 310 to position the electrical current transformer 100 about a power distribution line, with the split ends of split core 110 abutting each other when the housing 300 is pivoted into a closed position. The overmold portions 210 surrounding the split core 110 and secondary winding 120 advantageously provide electrical isolation and environmental protection for these components of the electrical current transformer. The clamshell sensor housing 300 may be held closed or drawn closed by various mechanisms, such as a snap-fit latch (not shown) disposed on the separable portions of the sensor housing opposite the hinge mechanism 310 or, more preferably, a screw-driven clamp (also not shown) engageable by a lineworker's “hot stick” device. Other forms of sensor housing and other closure mechanisms will be apparent to those of skill in the art, and are not considered to be critical elements of the electrical current transformer 100 as disclosed herein.

The embodiments of the invention shown in the drawings and described above are exemplary of numerous embodiments that may be made within the scope of the appended claims. It is contemplated that numerous other configurations recombining individual features or elements of the disclosed embodiments may be created by taking advantage of the disclosure as a whole. It is the applicant's intention that the scope of the patent issuing here from will be limited only by the scope of the appended claims.

What is claimed is:

1. An electrical current transformer for installation upon a power distribution line, the electrical current transformer comprising:
a generally annular, split current transformer core having a secondary winding including a first winding portion, wound with a first winding polarity about the split core, and a second winding portion, wound with a second, opposite winding polarity about the split core, and an intermediate tap.
a first rectifier, electrically connecting an output of the intermediate tap to a terminal of the first winding portion opposite the intermediate tap;
a second rectifier, electrically connecting the output of the intermediate tap to a terminal of the second winding portion opposite the intermediate tap; and
an intermediate tap control automatically controlling the output of the intermediate tap in response to a condition sensed in a circuit powered by the first and second rectifiers, wherein the intermediate tap is both electrically connectable to the output to provide an additive connection between the first and second winding portions, and electrically isolatable from the output to cause a subtractive connection between the first and second winding portions.

2. The electrical current transformer of claim 1, wherein the generally annular, split current transformer core is a magnetic core.

3. The electrical current transformer of claim 1, wherein the first winding portion is physically wound about the current transformer core in a first winding direction, the second winding portion is physically wound about the current transformer core in an opposite winding direction, and the end of the first winding portion is electrically connected to the start of the second winding portion through the intermediate tap.

4. The electrical current transformer of claim 1, wherein the first winding portion is physically wound about the current transformer core in a first winding direction, the second winding portion is physically wound about the current transformer core in the first winding direction, and the start of the first winding portion is electrically connected to the start of the second winding portion through the intermediate tap.

5. The electrical current transformer of claim 1, further comprising a first overvoltage protection portion electrically connecting the output of the intermediate tap to the terminal of the first winding portion opposite the intermediate tap, and a second overvoltage protection portion electrically connecting the output of the intermediate tap to the terminal of the second winding portion opposite the intermediate tap.

6. The electrical current transformer of claim 1, further comprising a voltage multiplier electrically connected to the first and second rectifiers and electrically powering the intermediate tap control.

7. The electrical current transformer of claim 1, wherein the intermediate tap control comprises an AC resistor network and an A/D microcontroller, the A/D microcontroller senses a condition in a circuit powered by the first and second rectifiers, and the A/D microcontroller controls the AC resistor network to vary the resistance of an electrical connection between the intermediate tap and the output of the intermediate tap.

8. The electrical current transformer of claim 1, where in the intermediate tap control is a switching control connecting the intermediate tap with the output of the intermediate tap.

9. The electrical current transformer of claim 8, wherein the intermediate tap control comprises a MOSFET switch and a pulse width modulator, the pulse width modulator senses a condition in a circuit powered by the first and second rectifiers, and the pulse width modulator automatically switches the MOSFET switch to alter a time fraction in which the intermediate tap is electrically isolated from the output of the intermediate tap.

10. The electrical current transformer of claim 8, wherein the intermediate tap control comprises a solid state optical relay, a triac, and a triac driver, the triac driver senses a condition in a circuit powered by the first and second rectifiers, and the triac driver automatically controls the solid state optical relay and triac to electrically connect or isolate the intermediate tap form the output of the intermediate tap.

11. An electrical current transformer for installation upon a power distribution line, the electrical current transformer comprising:
a generally annular, split current transformer core having a secondary winding including a first winding portion, wound with a first winding polarity about the split core for a number of turns, and a second winding portion, wound with a second, opposite winding polarity about the split core for an equal number of turns, and a cancellation tap.
a first rectifier, electrically connecting an output of the cancellation tap to a terminal of the first winding portion opposite the cancellation tap;
a second rectifier, electrically connecting the output of the cancellation tap to a terminal of the second winding portion opposite the cancellation tap; and
a cancellation tap control automatically controlling the output of the cancellation tap in response to a condition sensed in a storage capacitor powered by the first and second rectifiers, wherein the cancellation tap is normally electrically connected to the output but electrically isolatable from the output to effectively cancel current flow through the secondary winding.

12. The electrical current transformer of claim 11, wherein the generally annular, split current transformer core is a magnetic core.

13. The electrical current transformer of claim 11, wherein the first winding portion is physically wound about the current transformer core in a first winding direction, the second winding portion is physically wound about the current transformer core in an opposite winding direction, and the end of the first winding portion is electrically connected to the start of the second winding portion through the cancellation tap.

14. The electrical current transformer of claim 11, wherein the first winding portion is physically wound about the current transformer core in a first winding direction, the second winding portion is physically wound about the current transformer core in the first winding direction, and the start of the first winding portion is electrically connected to the start of the second winding portion through the cancellation tap.

15. The electrical current transformer of claim 11, further comprising a first overvoltage protection portion electrically connecting the output of the cancellation tap to the terminal of the first winding portion opposite the cancellation tap, and a second overvoltage protection portion electrically connecting the output of the cancellation tap to the terminal of the second winding portion opposite the cancellation tap.

16. The electrical current transformer of claim 11, further comprising a voltage multiplier electrically connected to the first and second rectifiers and electrically powering the cancellation tap control.

17. The electrical current transformer of claim 11, wherein the cancellation tap control comprises a solid state optical relay, a triac, a triac driver, and a storage capacitor monitoring circuit, wherein the storage capacitor monitoring circuit senses the condition in the storage capacitor, and wherein the triac driver and storage capacitor monitoring circuit automatically control the solid state optical relay and triac to electrically isolate the cancellation tap from the output of the cancellation tap.

18. The electrical current transformer of claim 17, further comprising the storage capacitor, wherein the storage capacitor is a supercapacitor.

19. The electrical current transformer of claim 11, wherein the cancellation tap control comprises a MOSFET switch and a pulse width modulator, the pulse width modulator senses the condition in the storage capacitor, and the pulse width modulator automatically switches the MOSFET switch to alter a time fraction in which the cancellation tap is electrically isolated from the output of the cancellation tap.

20. The electrical current transformer of claim 19, further comprising the storage capacitor, wherein the storage capacitor is a supercapacitor.
